(19) United States
(12) Patent Application Publication
(10) Pub. No.: US 2025/0148200 A1
(43) Pub. Date: May 8, 2025

(54) IDENTIFICATION OF RE-CLASSIFIABLE JOB POSTINGS

(71) Applicant: Wells Fargo Bank, N.A., San Francisco, CA (US)

(72) Inventors: Michael Bortis, Tustin, CA (US); Narsingh Rao Chatla, Hyderabad (IN); Siddharth Jain, Indore (IN); Guangcao Ji, Plano, TX (US); Carlton Jay Lindgren, Jr., Denver, CO (US); Srihita Nudurupati, Bangalore (IN); Pradyut Kumar Parida, Odisha (IN); Manesh Saini, New York, NY (US); Winthrop Treynor Smith, Littleton, CO (US); Ronald Sobey, Porter, TX (US); Omar Zeitoun, New York, NY (US)

(21) Appl. No.: 17/941,677

(22) Filed: Sep. 9, 2022

(51) Int. Cl. G06F 40/205; G06F 16/33; G06F 16/35; G06Q 10/1053

(52) U.S. Cl. CPC G06F 40/205; G06F 16/3334; G06F 16/35; G06Q 10/1053

(57) ABSTRACT

Determining job postings posted by one entity of an enterprise that are re-classifiable with respect to another entity of the enterprise. Computer systems and/or computer implemented methods use one or more reclassification analyses to compare an enterprise's active job postings with operations descriptions of entities of the job postings other than the entity that posted the job posting. A report and/or an alert can be generated when there is sufficient overlap between a job posting and an entity that did not post the job posting, indicating that the job posting is likely re-classifiable.

### BACKGROUND

Some business enterprises, such as large corporations, include several lines of business and/or departments. Each line of business and/or department can be independently responsible for staffing to meet its operational needs. In some situations, operational needs between different lines of business and/or departments can overlap, such that the business enterprise is better served if staffing of a given position is performed and vetted by a line of business or department other than the line of business or department that requests the position to be filled.

### SUMMARY

In general terms, the present disclosure is directed to identifying re-classifiable job postings.

In further general terms, the present disclosure is directed to reporting re-classifiable job postings in an easily navigable way.

Features of the present disclosure can perform one or more these functions in automated fashion.

Features of the present disclosure relate to computer-implemented systems and/or methods that can perform one or more of these functions in an automated fashion.

Features of the present disclosure relate to non-transitory computer readable media having stored thereon instructions, which, when executed by one or more processors, can be performed one or more of these functions in an automated fashion.

As used herein, a re-classifiable job posting is a job posting posted by one entity (such as a line of business or a department of a business enterprise) that has at least a predefined threshold relevance to one or more operations of a different entity of the business enterprise.

In one aspect, a computer-implemented method includes: parsing a text of a job posting posted by an entity into parsed text; performing at least two of: (i) searching for and identifying a keyword in the parsed text that matches a keyword of an operating description of another entity that did not post the job posting; (ii) scoring a similarity of the parsed text of the job posting to a parsed text of the operating description of the another entity and/or to parsed texts of other job postings posted by the another entity and determining that the similarity has a score that exceeds a predetermined minimum similarity score; and (iii) using a machine learning model to predict a categorization of the job posting that matches a categorization of the operating description of the another entity, the machine learning model being trained using historical job postings categorizations data; and based on the performing, determining that the job posting sufficiently matches the operating description of the another entity such that the job posting is re-classifiable to the another entity.

In another aspect, a computer-implemented method includes: parsing a text of a job posting posted by an entity of a business enterprise into parsed text; performing at least two of: (i) determining a number of keywords in the parsed text that match keywords of an operating description of an information technology (IT) department of the business enterprise that did not post the job posting and comparing the number to a predefined keyword threshold, and: if the number is at least as large as the predefined keyword threshold, generating a reclassification indicator; and if the number is less than the predefined keyword threshold, generating no reclassification indicator; (ii) scoring a similarity of the parsed text of the job posting to a parsed text of the operating description and/or to parsed texts of other job postings posted by the IT department and comparing a similarity score determined by the scoring to a predefined similarity threshold, and: if the similarity score is at least as large as the predefined similarity threshold, generating a reclassification indicator; and if the similarity score is less than the predefined similarity threshold, generating no reclassification indicator; and (iii) using a machine learning model to predict a categorization of the job posting, and: if the categorization matches a categorization of the operating description of the IT department by at least a predefined confidence threshold, generating a reclassification indicator; and if the categorization matches the categorization of the operating description of the IT department by less than the predefined confidence threshold, generating no reclassification indicator; if a number of reclassification indicators generated by the performing is at least two, determining that the job posting sufficiently matches the operating description of the IT department such that the job posting is reclassification with respect to the IT department; and if the number of reclassification indicators generated by the performing is less than two, determining that the job posting is not re-classifiable with respect to the IT department.

In another aspect, a system includes: one or more processors; and non-transitory computer-readable storage media encoding instructions which, when executed by the one or more processors, causes the system to: parse a text of a job posting posted by an entity of a business enterprise into parsed text; perform at least two of: (i) determine a number of keywords in the parsed text that match keywords of an operating description of an information technology (IT) department of the business enterprise that did not post the job posting and compare the number to a predefined keyword threshold, and: if the number is at least as large as the predefined keyword threshold, generate a reclassification indicator; and if the number is less than the predefined keyword threshold, generate no reclassification indicator; (ii) score a similarity of the parsed text of the job posting to a parsed text of the operating description and/or to parsed texts of other job postings posted by the IT department and compare a similarity score to a predefined similarity threshold, and: if the similarity score is at least as large as the predefined similarity threshold, generate a reclassification indicator; and if the similarity score is less than the predefined similarity threshold, generate no reclassification indicator; and (iii) use a machine learning model to predict a categorization of the job posting, and: if the categorization matches a categorization of the operating description of the IT department by at least a predefined confidence threshold, generate a reclassification indicator; and if the categorization matches the categorization of the operating description of the IT department by less than the predefined confidence threshold, generate no reclassification indicator; if a number of reclassification indicators generated by the at least two of the steps (i), (ii) and (iii) is at least two, determine that the job posting sufficiently matches the operating description of the IT department such that the job posting is re-classifiable with respect to the IT department; and if the number of re-classifiable indicators generated by the at least two of the steps (i), (ii) and (iii) is less than two, determine that the job posting is not re-classifiable with respect to the IT department.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 schematically shows components of an example system for determining and reporting re-classifiable job postings.

FIG. 2 is an example method that can be performed by the system of FIG. 1.

FIG. 3 is another example method that can be performed by the system of FIG. 1.

FIG. 4 is a schematic representation of a method that can be performed by the system of FIG. 1 using a machine learning model.

FIG. 5 is an example portion of an interface that can be generated using the system of FIG. 1.

FIG. 6 is a further example portion of an interface that can be generated using the system of FIG. 1.

FIG. 7 is a further example portion of an interface that can be generated using the system of FIG. 1.

FIG. 8 is a further example portion of an interface that can be generated using the system of FIG. 1.

FIG. 9 schematically shows example computing components of a computing device of the system of FIG. 1.

### DETAILED DESCRIPTION

The operations of large business enterprises can include multiple lines of business and/or departments. A financial institution is one example of such an enterprise, although this disclosure is not so limited. A typical financial institution can operate multiples lines of business and/or departments.

For a typical financial institution, lines of business can include, for example, commercial banking, consumer and small business banking, consumer lending, corporate and investment banking, corporate risk, finance, and wealth and investment management.

For a typical financial institution, departments can include, for example, human resources, internal audit, legal, public affairs, and information technology (IT).

As used herein, each line of business (LOB) and each department is considered an entity of the business enterprise. As used herein, a LOB is an entity that operates primarily to generate revenue for the enterprise. As used herein, a department is an entity that operates primarily to support one or more LOBs.

Each entity performs various operations. Some of the operations may be, within the enterprise at large, unique to the entity, while others may overlap with operations of other entities. For example, a LOB may require IT professionals to manage and maintain computing systems and software that may be unique, within the enterprise, to that LOB. For instance, the wealth and investment line of business (WAILOB) may be the only LOB or department within the enterprise that runs a particular investment trading and analysis software platform. IT professionals with specific programming expertise may be required to manage, maintain and update the software platform as needed, to access and manage the data the WAILOB uses to operate, and to train non-IT professionals to use the software platform. The WAILOB may not be aware of the IT department's experience and training requirements and policies for those managing WAILOB's computer systems, data and software.

Since enterprise entities (e.g., LOBs and departments) tend to operate independently of one another, it can occur that an entity can post a job posting specific to that entity that is relevant to operations of another entity and without the knowledge of, or consultation with, the other entity. For instance, the WAILOB may post a job posting for an IT professional without the knowledge of, or consultation with, the IT department. Meanwhile, in one example scenario, the IT department may already have the staff needed to fill the WAILOB's human resources need without the need for a new hire, such that the WAILOB's job posting and potential hire is inefficient and unnecessarily costly for the enterprise. In another scenario, the IT department may also be searching independently for an IT professional that could fill the WAILOB's human resources need, such that the WAILOB's job posting is redundant and thereby inefficient and unnecessarily costly for the enterprise. In another scenario, the IT department may simply be better suited to vet candidates for IT positions and select the best candidate for the position than the WAILOB, such that WAILOB's recruitment efforts for an IT professional reflect an inefficiency for the enterprise and the possibility of hiring a suboptimal candidate for the IT position when a more qualified candidate is available.

To reduce or eliminate these and other inefficiencies and unnecessary costs to the enterprise at large, there is a need to improve visibility and awareness of job posting activity between entities of the enterprise and, more specifically, to improve visibility and awareness of a job posting by one entity that is relevant to the operations of another entity within the same enterprise.

Aspects of the present disclosure can improve visibility and awareness of job postings between entities of the enterprise, including to improve visibility and awareness of a job posting by one entity that is relevant to the operations of another entity within the same enterprise. Thus, for example, an entity that did not post the job posting but to which the job posting has operational relevance is more likely to be able to take action with respect to the job posting by, e.g., participating in the hiring process or taking down the job posting if it is not needed.

As used herein, a re-classifiable job posting is a job posting by one entity of an enterprise that matches, by at least a predefined threshold relevance or matching magnitude, to one or more operations of another entity of the enterprise that did not post the job posting.

As used herein, a non-re-classifiable job posting is a job posting by one entity that has less than the predefined threshold relevance to one or more operations of another entity of the enterprise that did not post the job posting. Thus, some job postings can be re-classifiable with respect to one entity that did not post it, and non-re-classifiable with respect to another entity that did not post it. Other job postings can be non-re-classifiable with respect to all other entities that did not post it, meaning the only entity to which the job posting has at least the threshold relevance is the entity that posted the job posting.

Relevance of a job posting to an entity can be based on a comparison of the job posting's description to a description of the entity's operations. Relevance can be quantified numerically as scores.

Aspects of the present disclosure include determining job posting relevance, and thereby whether the posting is re-classifiable or not, using at least one type of relevance analysis.

Aspects of the present disclosure include determining job posting relevance, and thereby whether the posting is re-classifiable or not, using at least two different types of relevance analysis.

Aspects of the present disclosure include determining job posting relevance, and thereby whether the posting is re-classifiable or not, using at least three different types of relevance analysis.

Different types of relevance analysis will be described herein. When multiple types of relevance analysis are performed, the outputs of the analyses can be combined in some way to make the ultimate determination of whether the job posting is re-classifiable or not.

For instance, according to one example methodology, if two or three types of relevance analysis are performed, then if the outputs of at least two of the analyses include reclassification indicators, then the job posting is reported as re-classifiable, whereas if only one or zero of the outputs of the three analyses includes a reclassification indicator the job posting is considered non-re-classifiable and is not reported as re-classifiable.

According to another example methodology, if two types of relevance analysis are performed, then if the output of one of the analyses includes a reclassification indicator the relevance threshold for the output of the other analysis is lowered by a predefined magnitude. If the relevance meets the lowered output threshold for that analysis type, then the job posting is reported as re-classifiable, whereas if the relevance does not meet the lowered output threshold for that analysis type, then the job posting is considered non-re-classifiable and is not reported as re-classifiable.

Other methodologies are possible depending on the types and the number of types of relevance analyses available to be performed on a given job posting.

Aspects of the present disclosure include automatically determining a re-classifiable job posting and reporting the re-classifiable job posting via a user interface to the relevant entity that did not post the job posting so that the relevant entity can take remedial action with respect to the job positing. Such remedial action can include one or more of contacting the entity that did post the job posting, causing the job posting to be taken down, and becoming involved with the hiring process associated with the job posting. Other remedial actions are possible.

Further aspects of the present disclosure include filtering out non-re-classifiable job postings.

It can be appreciated that by automated determination and reporting of re-classifiable job postings, several practical applications can be realized.

According to one example practical application, aspects of the present disclosure position a business enterprise to minimize workforce cost while maximizing workforce talent.

According to another example practical application, staffing visibility between independently operated entities of a business enterprise is improved.

According to another example practical application, only re-classifiable job postings are reported to an entity that did not post the job posting, reducing unnecessary review of irrelevant job postings.

According to another example practical application, re-classifiable job postings are identified that otherwise would not have been identified.

According to another example practical application, user-friendly computer-generated interfaces can be provided to facilitate and streamline navigation by an entity of re-classifiable job postings, facilitating the entity's ability to take remedial action with respect to re-classifiable job postings it otherwise would not have been aware of.

Aspects of the present disclosure are rooted in improvements in computer technology. For example, a machine learning model can be constructed, trained and used in a new way. For instance, the model (e.g., a neural network) can include one or more algorithms that can be trained to predict whether a job posting is relevant to an entity that did not post the job posting.

Further improvements, advantages and practical applications will be borne out by the present disclosure.

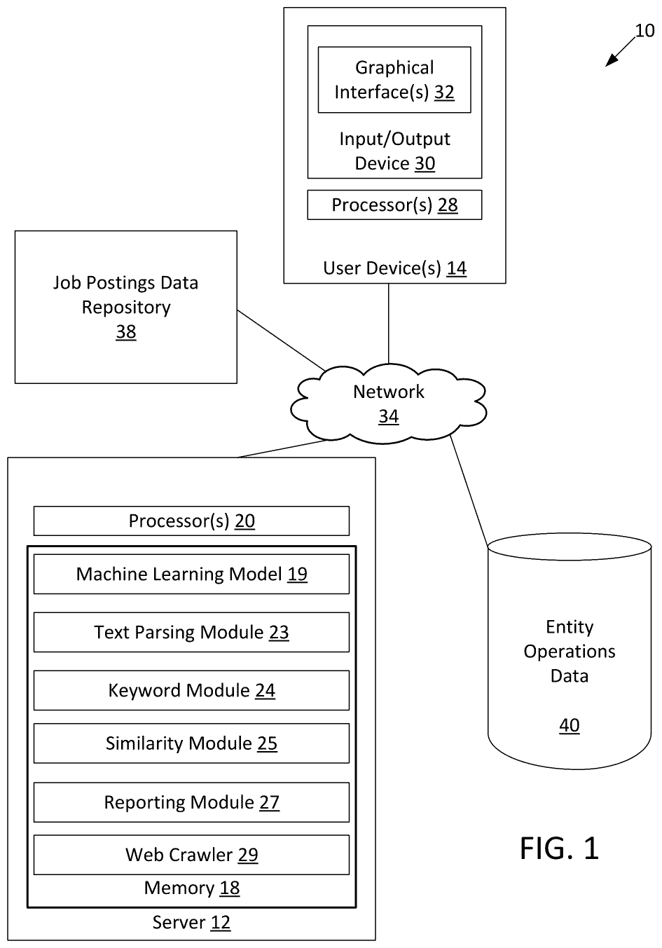

FIG. 1 schematically shows components of an example system 10 according to the present disclosure. The system 10 includes a server 12 and one or more user device(s) 14.

Each user device 14 is a computing device, such as a laptop computer, a desktop computer, a tablet computer, a smartphone, etc.

In some examples, one of the user devices 14 can be associated with a stakeholder of an entity of an enterprise who is tasked with addressing job postings relevant to the entity that have been posted by another entity of the enterprise.

The server 12 is one or more computing devices configured to determine (e.g., identify) and report re-classifiable job postings that can be viewed and navigated using the one or more user devices 14.

To perform these functions, the server 12 can include a machine learning model 19, a text parsing module 23, a keyword module 24, a similarity module 25, and a reporting module 27. Each of the modules 19, 23, 24, 25 and 27 can be stored on a memory 18 of the server 12.

The server 12 can be associated with a given enterprise (such as a financial services institution or other business enterprise). The server 12 can be configured to be accessed only by the enterprise to which it is associated, and in certain situations only by certain authorized employees of the enterprise, such as specific stakeholders of specific entities. Alternatively, the server 12 can correspond to shared computing resources, such as a cloud, to which a given enterprise can gain access for their private computing needs.

The server 12 includes one or more processor(s) 20 configured to process data and execute computer readable instructions stored on the memory 18, for performing functions of the server 12 described herein. For example, the processor(s) 20 can be configured to carry out the functionality of the modules 19, 23, 24, 25 and 27.

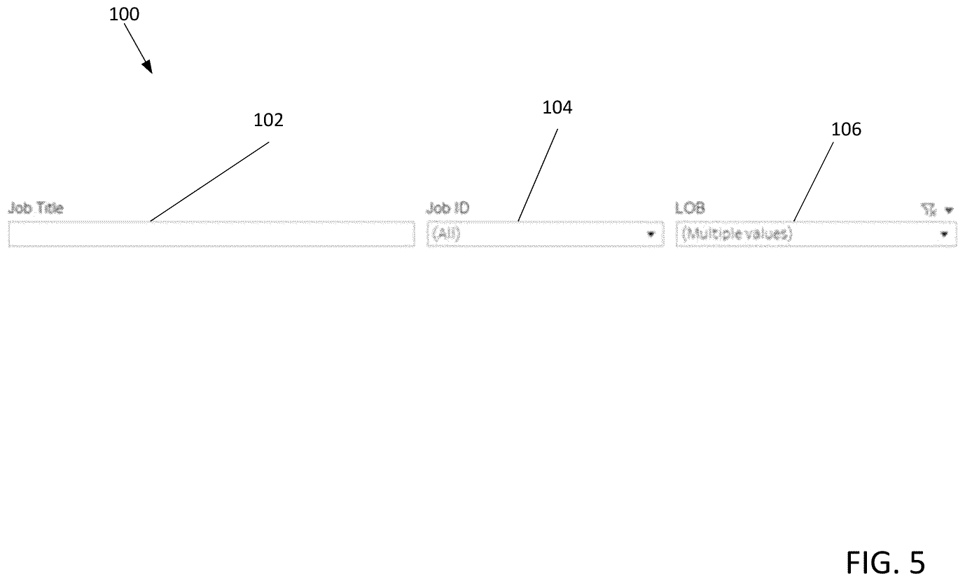

Each user device 14 includes one or more processor(s) 28 and an input/output (I/O) device 30. The I/O device 30 is configured to generate graphical interface(s) 32 (such as an interface that includes the interface portions 100, 108, 114 and 120 described below with reference to FIGS. 5-8), and/or audio interfaces. For example, the I/O device 30 can include a touch screen, a microphone and/or a speaker.

The processor(s) 28 can execute computer readable instructions for performing functions of the user device 14, such as displaying graphical interfaces and otherwise providing output for a user (e.g., the stakeholder) to see or hear, and receive input from the user.

The system 10 includes a job postings data repository 38. The repository can include one or more databases that store data related to current and historical job postings. Such data can include, for example, the text of historical inactive job postings and current and active job postings, as well metadata, such as metadata indicating the entity that posted each job posting, data identifying the types of data fields populated by the text, when the job posting was posted, whether the posting is active or inactive, and so forth. The job postings data can reflect job postings posted only by the enterprise associated with the server 12. Alternatively, the job postings data can also reflect job postings posted by other business enterprises.

The repository 38 can also include one or more web pages accessible via a web crawler 29 stored on the memory 18 of the server 12. The web crawler 29 can include software configured to automatically access public webpages, and scan and pull text from those webpages, such as webpages containing text of job postings. Thus, the web crawler 29 can be a tool by which the server 12 accesses job postings data. For instance, at least some of the job postings data processed by the server 12 can be stored on webpages that can be accessed and read by the web crawler 29.

The repository 38 can include one or more databases associated with the enterprise, a shared storage to which the enterprise can gain access, and/or webpages accessible by the web crawler 29, such as web pages of third party job recruiters.

The system 10 includes entity operations data storage 40. The storage 40, and the entity operations data are accessible by the enterprise. Entity operations data includes data pertaining to operations performed by entities of the enterprise. The data can be organized by entity. Such data can include textual descriptions of the various entities' operations. Such data can also include metadata associated with the operations, such as data field labels, the associated entity (e.g., department or LOB), the associated stakeholders, and so forth. The entity operations data can also be accessed by the web crawler 29 from webpages, such as webpages from the enterprise's website.

In some examples, the entity operations data can include historical job postings posted by that entity. Job postings can include information reflecting operations of the entity that posted the job posting. Thus, in some examples the entity operations data can be derived, by the system 12, from historical job postings that have been tagged with metadata identifying the entity that posted them.

The server 12, the user device(s) 14, the repository 38, and the storage 40 are interconnected via a network 34. The network 34 can be any suitable data network, such as the internet, a wide area network, a local area network, a wired network, a wireless network, a cellular network, a satellite network, a near field communication network, or any operatively connected combination of these. Inputs to the user device(s) 14 can be received by the server 12 via the network 34 and vice versa.

The text parsing module 23 is configured to parse text of job postings pulled from the repository 38 into a format or formats that can be processed by the keyword module 24, the similarity module 25, and the machine learning model 19. For example, the text parsing module 23 can be configured to eliminate punctuation and special characters, to eliminate strings of text that are non-informative, to concatenate groups (e.g., phrases) of words into elements that can be interpreted together, to interpret strings of text and replace those strings with interpretations, and so forth.

Examples of non-informative text can include various parts of speech recognized the text parsing module 23, such as articles, prepositions, conjunctions, numbers, as well as broadly applicable and generic job requirements, such as communication skills, multitasking ability, and the like.

In some examples, how text strings are manipulated and/or interpreted by the text parsing module 23 can be based on the data field in which the text is found and/or other metadata. The text parsing module 23 can also be configured to tag job postings text according to the entity that posted the job posting and according to whether the job posting is active or inactive, based on the job posting metadata.

The text parsing module 23 is also configured to parse text of job postings pulled from the repository 38 by breaking down the job listings into different sections. Non-limiting examples of such sections can include a role section, an experience section, and a qualifications section. A role section of a job posting can include information that describes the responsibilities of the job. An experience section of a job posting can include information about the amount and type of past job experience or education expected or desired for a candidate for the job. A qualifications section of a job posting can include information that describes expected or desired qualifications for a candidate of the job, such as specific types or levels of education and/or professional degrees or certifications for the candidate.

The text parsing module 23 is configured to parse text (as described above) of the entity operations data 40 into a format or formats that can be processed by the keyword module 24, the similarity module 25, and the machine learning model 19. The text parsing module 23 can also be configured to tag entity operations data according to the entity associated with those operations, based on the entity operations metadata.

The keyword module 24 is configured to compare parsed text of active job postings data tagged with the associated entity to parsed text of entity operations data tagged with the associated entity other than the entity/entities that posted the job postings. The keyword module 24 is configured to match specific keywords between the parsed texts. The keywords can be predefined and based on the operations of the entity submitting the query. For example, if an IT department of an enterprise submits a query via the user device 14 for any re-classifiable job postings posted by other entities of the enterprise, the keyword module 24 is configured to look for IT related keywords or key phrases in the parsed text of active job postings associated with non-IT department entities of the enterprise. Such keywords or phrases could include, for example, IT, information technology, software, hardware, data engineer, systems analyst, and so forth. Thus, the keywords or phrases that are searched by the keyword module 24 can be entity specific and different for different entities.

If the keyword module 24 matches a predefined operations specific keyword or phrase (or other predefined text string) between the job posting text and the entity operations text, the keyword module 24 is configured to output a reclassification indicator. If the keyword module 24 does not match a predefined operations specific keyword or phrase (or other predefined text string) between the job posting text and the entity operations text, the keyword module 24 is configured not to output a job posting reclassification indicator.

In other examples, if the keyword module 24 matches at least a predefined threshold number (e.g., 10 keywords or 10 key phrases) of keyword or key phrase matches between the job posting text and the entity operations text for a specific entity that is not the entity that posted the job posting, the keyword module 24 is configured to output a reclassification indicator. If the keyword module 24 does not match at least the threshold number of keywords or key phrases, the keyword module 24 is configured not to output a job posting reclassification indicator.

The keyword module 24 can operate on a section level, meaning that it can perform its keyword matching on a section by section basis from the parsed text. For example, instead of finding and matching keywords between two entire job postings, the keyword module 24 can be configured to find and match keywords between corresponding sections of the job postings, such as between the role sections, between the experience sections, and/or between the qualifications sections of the corresponding job postings.

Upon submission of a query for any re-classifiable job postings posted by other entities of the enterprise, the similarity module 25 is configured to compare parsed text of active job postings data tagged with entities other than the requesting entity to parsed text of entity operations data tagged with the requesting entity and/or with parsed text of historical job postings posted by the requesting entity.

More generally, and even in the absence of a specific query, the similarity module 25 is configured to compare parsed text of active job postings data tagged with the associated entity to parsed text of entity operations data tagged with an associated entity other than the entity/entities that posted the active job postings and/or to parsed text of historical job postings tagged with the associated entity other than the entity/entities that posted the active job postings, and to assign a similarity score to the texts as a whole based on the comparison.

Alternatively, the similarity module 25 is configured to compare texts of sections of the overall texts to each other and score a similarity between corresponding sections of corresponding texts (such as between role sections of two job postings, between experience sections of two job postings, and/or between qualifications sections of two job postings).

The similarity module 25 can include a natural language processor and perform natural language processing to interpret the texts or sections of the texts it is comparing and assess and score the similarity therebetween.

The similarity module 25 is configured to compare the overall texts to each other and score a similarity between the texts or sections of texts. The score can depend, for example, on a number of parsed text elements (with non-informative text eliminated) that match or partially match between the texts being compared. For instance, one point can be scored for each partial match between text elements, and two points can be scored for each exact match. An example of a partial match between elements is the element “systems analyst” in one parsed text and the element “system administrator” in the other parsed text. The similarity module 25 is configured to add up the scores from the matches and partial matches. If the sum of the scores is at least a predefined threshold score, then the similarity module 25 is configured to output a job posting reclassification indicator. If the sum of the scores is not at least the predefined threshold score, then the similarity module is configured not to output a job posting reclassification indicator.

Other scoring methodologies are possible, e.g., with different scoring weights being applied to different types of textual elements that are compared, and/or different scoring weights being applied based on the type of entity requesting a job posting reclassification report. For example, if the requesting entity is the IT department, greater weight can be applied by the similarity scoring module 25 when partial or exact matches are identified between textual elements that are of a computer technology nature, than if the requesting entity is the legal department.

The machine learning model 19 is configured to predict a re-classifiable job posting based on the parsed job posting text. More specifically, the machine learning model 19 includes a trained algorithm (e.g., a neural network) configured to predict re-classifiable job postings. For example, the machine learning model 19 can include an algorithm with parameters tuned to minimize an error function between actual and predicted outcomes of re-classifiable job postings. To minimize the error function, the machine learning algorithm(s) can be trained using a corpus of historical job postings each known to be re-classifiable or non-re-classifiable to different enterprise entities that did not post the job postings. The corpus of historical job postings used for training can be retrieved from the repository 38.

In some examples, the machine learning model 19 can be trained on a section by section basis using a corpus of historical job postings each known to be re-classifiable or non-re-classifiable to different enterprise entities that did not post the job postings, and each historical job posting being parsed into different sections, such as a role section, an experience section, and a qualifications section. Appling its training, the machine learning model 19 is configured to predict re-classifiable job postings by applying a machine learning algorithm on a section by section basis.

In some examples, the machine learning model 19 performs vector analysis on current job postings (or one or more sections thereof) to align them with historical job postings (or one or more corresponding sections thereof) of known entities. Each active job posting can be represented as a vector, with each vector being a composite representation in multi-dimensional space of numerous parameters that have some indication of relevance to the entity that should have posted the job posting, as learned by the machine learning model from the historical data. The machine learning model 19 is trained to apply a confidence score to a prediction that a job posting is re-classifiable based on the vector analysis or other methodology. If the applied confidence score for a prediction that a job posting is re-classifiable is at least a predefined threshold confidence score (e.g., at least 80 percent confidence), then the machine learning model 19 is configured to output a job posting reclassification indicator. If the applied confidence score for a prediction that a job-positing is re-classifiable is less than the predefined confidence score, then the machine learning model is configured not to output a job posting reclassification indicator.

The reporting module 27 is configured to receive reclassification indicators from each of the keyword module 24, the similarity module 25, and the machine learning model 19. The reporting module 27 is further configured to process the received reclassification indicators and determine whether a reclassification report is warranted based on the reclassification indicators it receives, if any. If a reclassification report is determined to be warranted, the reporting module 27 is configured to generate a reclassification report, e.g., in response to a query by a stakeholder of an entity of the enterprise. The report generated by the reporting module 27 can be viewed and/or navigated through using the user device 14. The report generated by the reporting module 27 can identify any and all active job postings posted by the enterprise that are re-classifiable with the requesting entity.

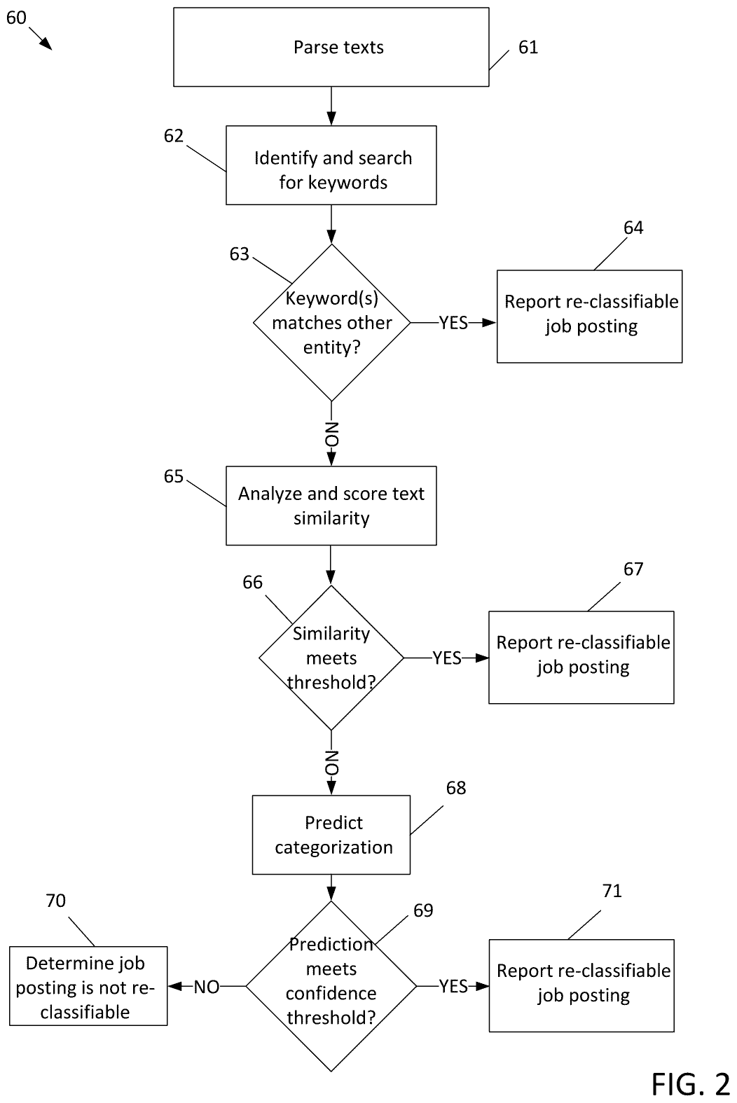

FIG. 2 is an example method 60 that can be performed by the system of FIG. 1. Example steps of the method will be described. Not all the steps need be performed, nor in the order shown in FIG. 2. In some examples, the method 60 is preceded by a request or query for a job posting reclassification report with respect to a specific entity of an enterprise. For instance, a stakeholder of the IT department of a financial institution can submit the request. In some examples, the method 60 is preceded by training the machine learning model 19 (FIG. 1).

At a step 61 of the method 60, the texts of job postings descriptions and the texts of entity operations are parsed. This step can be performed, e.g., by the text parsing module 23 (FIG. 1). In some examples, the entity operations text that is parsed is the entity operations text of the entity that has submitted a request or query for a job posting reclassification report.

At a step 62 of the method 60, one or more keywords and/or key phrases identified for a specific entity (e.g., the entity requesting the reclassification report) and those keywords or key phrases identified are then searched for in the job postings text. This step can be performed, e.g., by the keyword module 24 (FIG. 1).

At a step 63 of the method 60, it is determined, e.g., by the keyword module 24, whether there are any keyword matches between the parsed job posting text and the entity operations description of an entity other than the entity that posted the job posting (e.g., the requesting entity). If there are keyword or key phrase matches, or at least a predefined minimum number of such matches, then a re-classifiable job posting has been determined and the method 60 advances to the step 64 in which the re-classifiable job posting is reported, e.g., by the reporting module 27.

If there are no keyword or key phrase matches, or fewer such matches than a predefined minimum number, then the method advances to a step 64 in which the parsed job posting texts and the operations description text of the entity in question are compared and scored for similarity, e.g., by the similarity module 25 (FIG. 1). At a step 66, it is determined whether the similarity score calculated at the step 65 meets a predefined threshold score. If it does meet a predefined threshold score, then a re-classifiable job posting has been determined and the method 60 advances to the step 67 in which the re-classifiable job posting is reported, e.g., by the reporting module 27.

If at the step 66 the similarity score calculated at the step 65 does not meet the predefined threshold, then the method advances to a step 68 in which the parsed job posting texts and/or the operations description text of the entity in question are input to the machine learning model 19 (FIG. 2) and a categorization of the job posting (e.g., as non-re-classifiable or re-classifiable) is predicted by the machine learning model 19 and the prediction is assigned a confidence score by the machine learning model. At a step 69, it is determined whether the confidence score for a re-classifiable categorization determined at the step 68 meets a predefined threshold confidence score. If it does meet the predefined threshold confidence score, then a re-classifiable job posting has been determined and the method 60 advances to the step 71 in which the re-classifiable job posting is reported, e.g., by the reporting module 27.

If, at the step 69, it is determined that the confidence score of a predicted re-classifiable categorization does not meet the predefined threshold score, then a determination is made (e.g., by the reporting module 27) that the job posting is not re-classifiable.

The method 60 includes three different job posting reclassification analyses. In some examples, only one of the analyses is performed to determine if a job posting is re-classifiable. In some examples, only two of the analyses are performed to determine if there a job posting is re-classifiable. In some examples, all three of the analyses are performed to determine if a job posting is re-classifiable. Additional analyses may also be performed.

In some situations, one of the analyses may be more reliable (e.g., output fewer false reclassification indicators) than another one of the analyses. For example, if no specific entity has requested to be notified of any re-classifiable job postings, the text similarity analysis may be a more reliable predictor of re-classifiable job posting generally across the enterprise than the key word matching analysis. This is because the key word analysis can be more reliable when searching for keywords or key phrases that are specific to the operations of a specific entity, e.g., a requesting entity.

However, in some examples, and even without a requesting entity, the keyword or key phrase analysis can be performed reliably by differentiating the key words or key phrases searched for depending on the type of entity. For example, a job posting is posted by the WAILOB. To determine if the job posting is re-classifiable with the IT department, certain keywords or phrases are searched that are specifically relevant to IT and not to another entity, whereas to determine if the job posting is re-classifiable with the legal department, different keywords or phrases are searched that are specifically relevant to the legal department and not to IT or another entity.

Though FIG. 2 illustrates the method 60 as including three different analyses performed in sequence, in some examples, the method 60 can include only the keyword analysis. In other examples, the method 60 can include only the similarity analysis. In other examples, the method 60 can include only the machine learned categorization analysis. In other examples, the method 60 can include any two or all three of the analyses performed in parallel. In other examples, the method 60 can include any two or all three of the analyses performed sequentially. Additional analyses can also be performed.

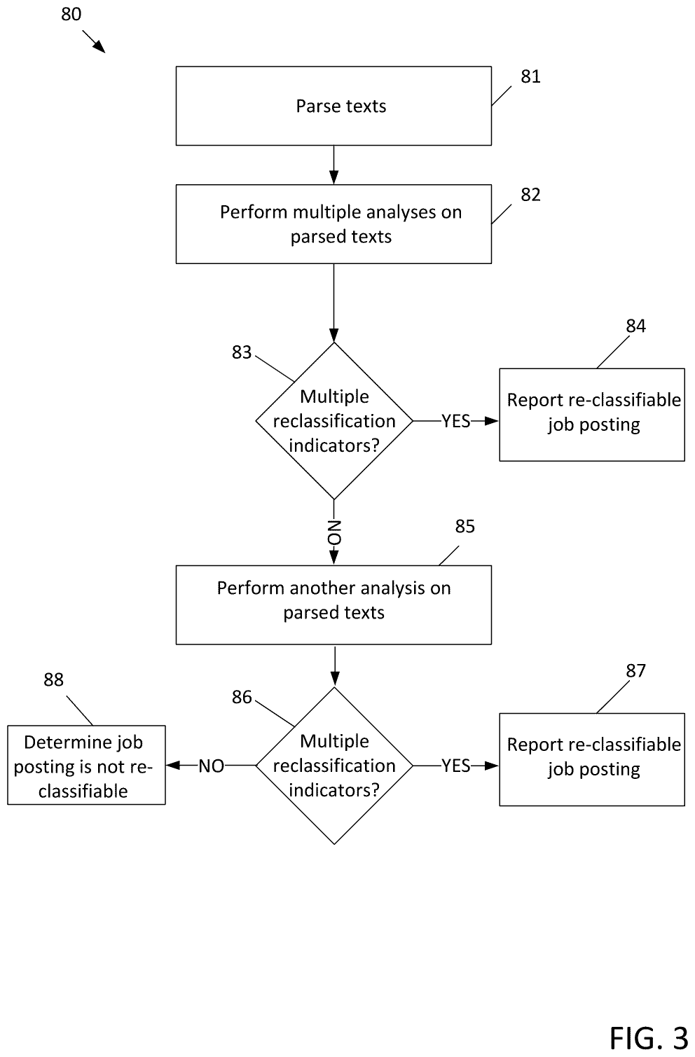

FIG. 3 is another example method 80 that can be performed by the system of FIG. 1. Example steps of the method 80 will be described. Not all the steps need be performed, nor in the order shown in FIG. 3. In some examples, the method 80 is preceded by a request or query for a job posting reclassification report with respect to a specific entity of an enterprise. For instance, a stakeholder of the IT department of a financial institution can submit the request. In some examples, the method 80 is preceded by training the machine learning model 19 (FIG. 1).

At a step 81 of the method 80, the texts of job postings descriptions and the texts of entity operations are parsed. In some examples, this step can also include natural language understanding of the texts and parsing of the texts into different sections, such as role, experience, and qualifications sections. This step can be performed, e.g., by the text parsing module 23 (FIG. 1) and/or the similarity module 25 (FIG. 1). In some examples, the entity operations text that is parsed is the entity operations text of the entity that has submitted a request or query for a job posting reclassification report.

At a step 82, at least two (in some cases, three or more) different job posting reclassification analyses are performed on the parsed texts. The analyses can include two or more of a keyword or phrase matching analysis, a similarity scoring analysis, and a machine learning model prediction analysis. These non-limiting analyses are described herein.

In some examples, at least two of the multiple analyses at the step 82 are performed in parallel. In other examples, the analyses performed at the step 82 are performed sequentially.

At a step 83, it is determined whether the analyses performed at step 82 have resulted in at least two reclassification indicators. For example, if the key word or phrase matching analysis was performed and at least a threshold number of words or phrases matched, then the keyword module 24 outputs a reclassification indicator; otherwise, the keyword module 24 does not output a reclassification indicator. Similarly, if the similarity scoring analysis was performed and at least a threshold similarity score was determined then the similarity module 25 outputs a reclassification indicator; otherwise, the similarity module 25 does not output a reclassification indicator. Similarly, if the machine learning model prediction analysis was performed and at least a threshold confidence score was determined then the machine learning model 19 outputs a reclassification indicator; otherwise, the machine learning model 19 does not output a reclassification indicator.

As discussed above, thresholds (e.g., the keyword or phrase matching number threshold, the similarity score threshold, and the confidence threshold) can be adjusted based on the outcomes of other analyses. For instance, if the analyses at the step 82 are performed sequentially, the keyword or phrase matching number threshold can be reduced if the similarity scoring analysis performed earlier in the sequence outputs a reclassification indicator, and vice versa, if the similarity scoring analysis is performed after the keyword or phrase matching analysis.

The step 83 can be performed by, e.g., the reporting module 27 (FIG. 1). If, at the step 83 it is determined that there are multiple reclassification indicators, then the method 80 proceeds to the step 84 and the reporting module 27 reports the re-classifiable job posting. The reporting can be in the form of an alert directed to stakeholder of the entity that did not post the job posting but with which the job posting is re-classifiable. In other examples, the stakeholder can submit a request and access a report of re-classifiable job postings via a dashboard on a user interface.

If, at the step 83 it is determined that there are not multiple reclassification indicators, then in some examples, the method 80 proceeds to the step 85 in which another reclassification analysis is performed on the parsed texts. For instance, if keyword and text similarity analyses were performed at the step 83, then the machine learning model prediction analysis is performed at the step 85.

At the step 86, it is again determined, following the additional analysis, whether the analyses performed at step 82 and 85 have resulted in the generation of at least two reclassification indicators.

If, at the step 86 it is determined that multiple reclassification indicators have been generated, then the method 80 proceeds to the step 87 and the reporting module 27 reports the re-classifiable job posting. The reporting can be in the form of an alert directed to stakeholder of the entity that did not post the job posting but with which the job posting is re-classifiable. In other examples, the stakeholder can submit a request and access a report of re-classifiable job postings via dashboard on a user interface.

If, at the step 86 it is determined that there are not multiple reclassification indicators, then in some examples the method 80 proceeds to the step 88 in which it is determined that the job posting is not re-classifiable and no reclassification report is generated.

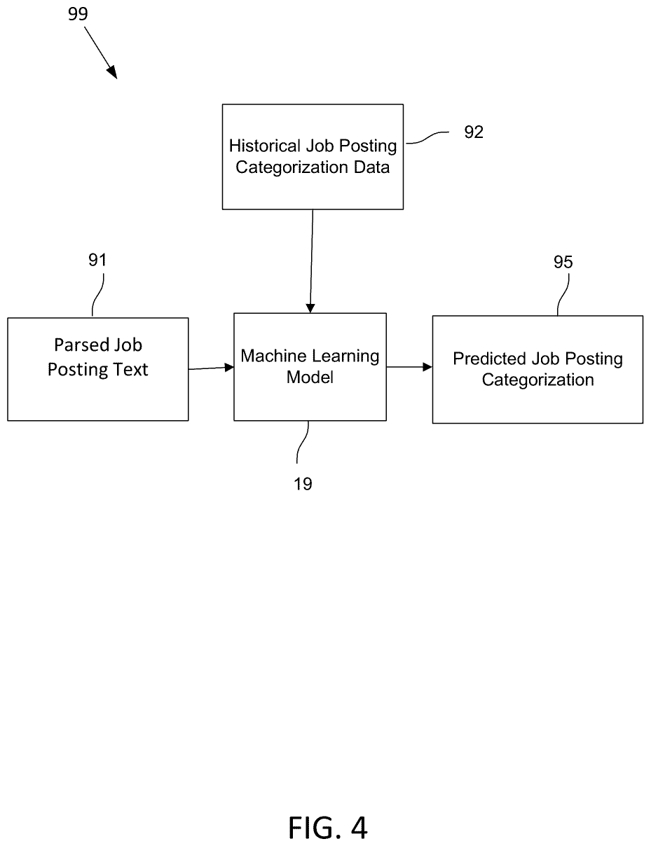

FIG. 4 is a schematic representation of a method 99 that can be performed by the system of FIG. 1 using a machine learning model. The method 99 includes the machine learning model 19. As part of the method 99, the machine learning model 19 can be trained using historical job posting categorization data 92, which can include parsed texts of historical job postings and their entity categorizations.

The trained machine learning model 19 receives input 91. The input 91 can include parsed job posting text, with the parsing having been performed by the parsing module 23 (FIG. 1). In some examples, the machine learning model 19 receives the input 91 in response to a stakeholder's request for a job posting reclassification report. The input 91 can include parsed text of every active job posting posted by entities of the enterprise. In some examples, the input 91 does not include job postings posted by the entity associated with the requesting stakeholder.

In other examples, the machine learning model 19 receives the input 91 independent of any stakeholder request for a job posting reclassification report.

The trained machine learning model 19 processes the input 91 and generates output 95 based on how the model 19 was trained. The output 95 includes a predicted categorization for the job posting input and an associated confidence score for the prediction. The categorization, for example, can be a re-classifiable categorization or a non-re-classifiable categorization, and an associated confidence score.

FIG. 5 is an example portion 100 of an interface that can be generated using the system of FIG. 1. The interface that includes the portion 100 can be a job posting reclassification management dashboard generated by the reporting module 27 (FIG. 1) and can be displayed via the user device 14 (FIG. 1). The interface portion 100 includes a query bar for requesting a job posting reclassification report. Thus, the query bar can be presented to a stakeholder of an entity of the enterprise. The stakeholder enters request information into the data fields 102, 104, 106, e.g., via pre-populated dropdown menus. In this manner, the stakeholder can focus the job posting reclassification search to active job postings having certain criteria, such as a certain job title, a certain job ID, and/or job postings posted by one or more selected LOBs.

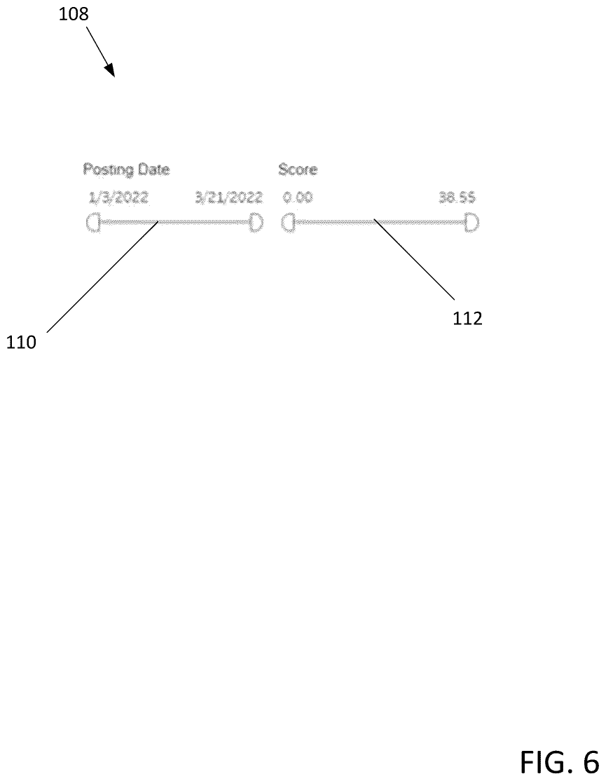

FIG. 6 is a further example portion 108 of an interface that can be generated using the system of FIG. 1. The interface portion 108 can be a portion of the dashboard just described. The interface portion 108 can be generated by the reporting module 27 (FIG. 1) and can be displayed via the user device 14 (FIG. 1). The interface portion 108 includes slide bars 110 and 112 that the stakeholder can adjust to further focus which job postings are considered for possible reclassification with the stakeholder's entity. The slide bar 110 allows the stakeholder to select and adjust a range of dates that the considered job postings were posted in. The slide bar 112 allows the stakeholder to select how sensitive the one or more reclassification analyses is/are. That is, by adjusting the slide bar 112, the keyword or phrase number threshold, the similarity score threshold, and/or the machine learning model confidence threshold can be adjusted.

The information entered into the interface portions 100 and/or 108 is submitted to the server 12 from the user device 14 (FIG. 1).

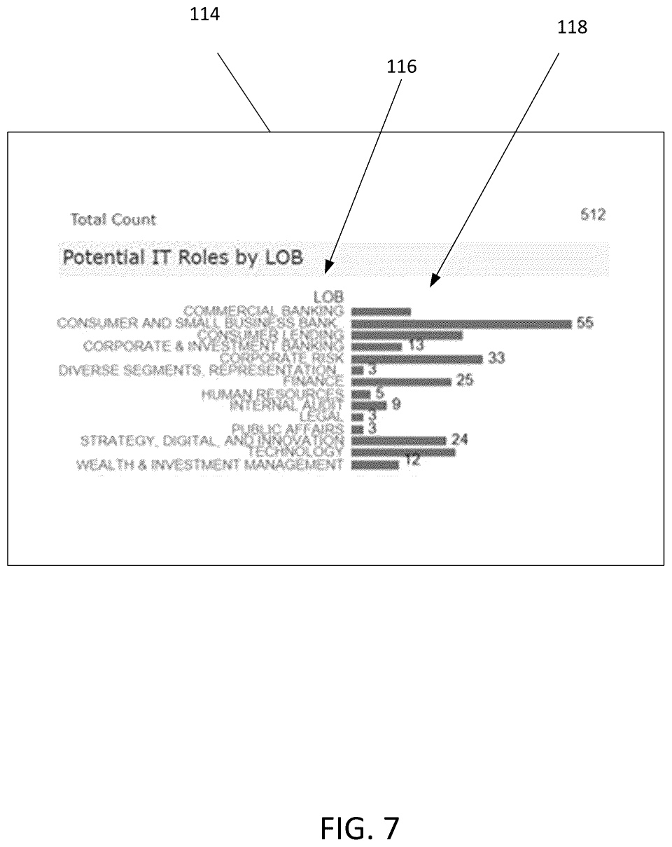

FIG. 7 is a further example portion 114 of an interface that can be generated using the system of FIG. 1. The portion 114 can be a portion of the dashboard just described. The interface portion 114 can be generated by the reporting module 27 (FIG. 1) and can be displayed via the user device 14 (FIG. 1). The interface portion 114 can be generated in response to the stakeholder input into the interface portions 100 and/or 108, and by using one or more of the job posting reclassification analyses described herein.

The interface portion 114 includes a job posting reclassification report based on criteria or filters selected by the stakeholder of an entity. The report indicates a total number of re-classifiable job posting identified by the system 10 (FIG. 1). The report also breaks down the re-classifiable job postings by LOB 116, and includes a graphic indicating how many re-classifiable job postings were determined for each LOB that is not the LOB of the stakeholder making the request.

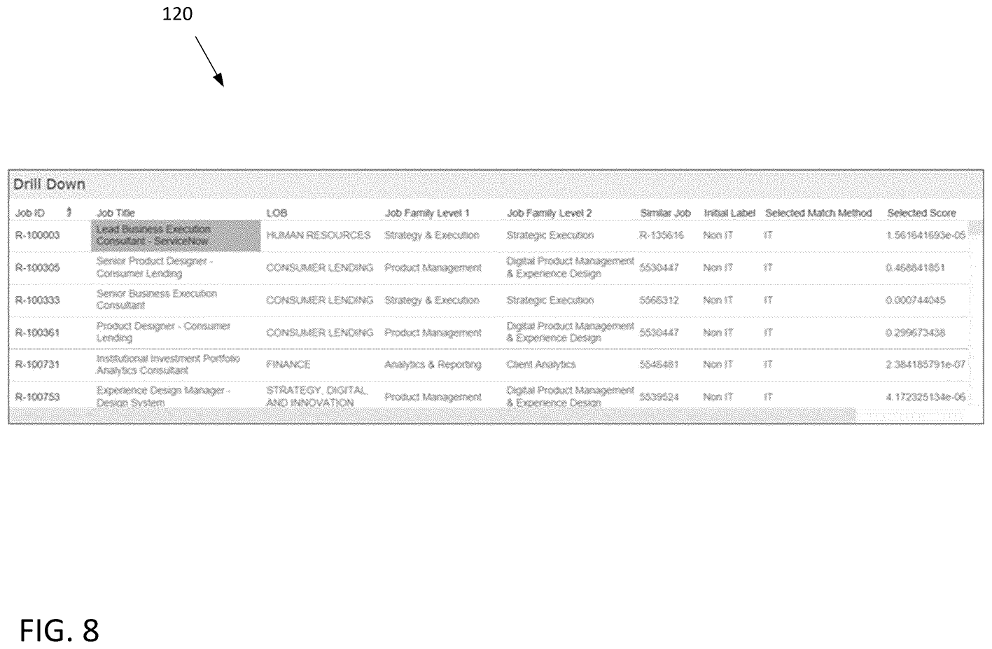

FIG. 8 is a further example portion of an interface 120 that can be generated using the system of FIG. 1. The portion 120 can be a portion of the dashboard just described. The interface portion 120 can be generated by the reporting module 27 (FIG. 1) and can be displayed via the user device 14 (FIG. 1). The interface portion 114 can be generated in response to the stakeholder input into the interface portions 100 and/or 108, and by using one or more of the job posting reclassification analyses described herein.

The interface portion 120 includes a report containing details about specific job postings determined by the system 10 (FIG. 1) to be re-classifiable with the entity of the requesting stakeholder. The report includes, for example, for each re-classifiable job posting identified, the job posting's title, the LOB that posted the re-classifiable job posting, details about the job family, and the likelihood that the job posting is re-classifiable. Other information can also be presented in the report.

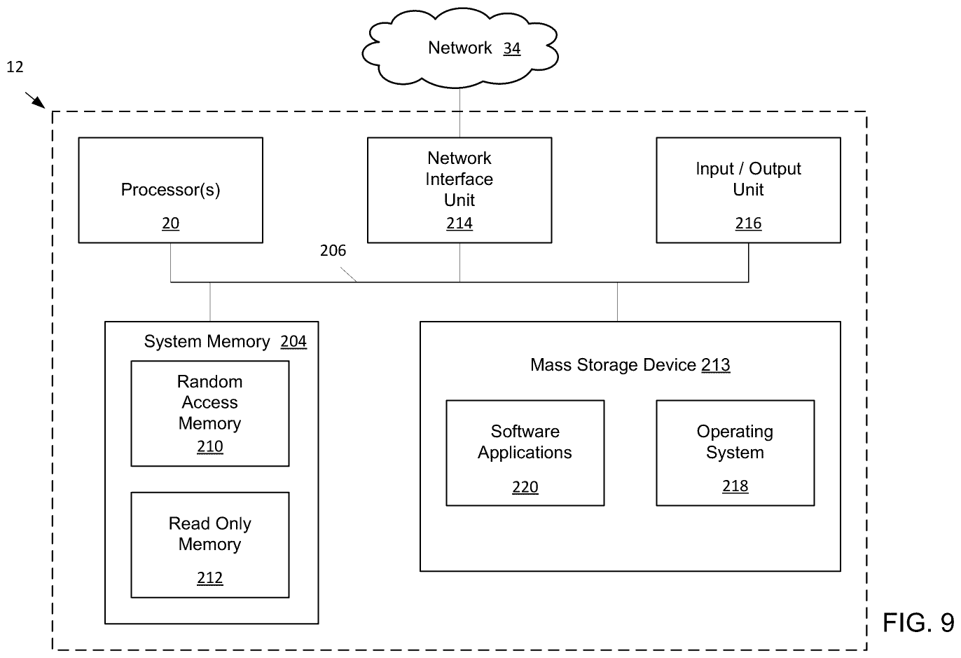

Additional components of the server 12 are illustrated in FIG. 9. In this example, the server 12 provides the computing resources to perform the functionality associated with the system 10 (FIG. 1). The user device(s) 14 and other computing resources associated with the system 10 can be similarly configured.

The server 12 can be an internally controlled and managed device (or multiple devices) of the enterprise. Alternatively, the server 12 can represent one or more devices operating in a shared computing system external to the institution or enterprise, such as a cloud. Further, the other computing devices disclosed herein can include the same or similar components, including the user device(s) 14.

Via the network 34, the components of the server 12 that are physically remote from one another can interact with one another.

The server 12 includes the processor(s) 20, a system memory 204, and a system bus 206 that couples the system memory 204 to the processor(s) 20.

The system memory 18 includes a random access memory (“RAM”) 210 and a read-only memory (“ROM”) 212. A basic input/output system that contains the basic routines that help to transfer information between elements within the server 12, such as during startup, is stored in the ROM 212.

The server 12 further includes a mass storage device 213. The mass storage device 213 can correspond to the memory 18 of the system 10 (FIG. 1). The mass storage device 213 is able to store software instructions and data, such as the modules 19, 23, 24, 25, and 27, and the web crawler 29 (FIG. 1). The mass storage device 213 can also include the entity operations data 40 (FIG. 1).

The mass storage device 213 is connected to the processor(s) 20 through a mass storage controller (not shown) connected to the system bus 206. The mass storage device 213 and its associated computer-readable data storage media provide non-volatile, non-transitory storage for the server 12. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server 12.

According to various embodiments of the invention, the server 12 may operate in a networked environment using logical connections to remote network devices through the network 34, such as a wireless network, the Internet, or another type of network. The server 12 may connect to the network 34 through a network interface unit 214 connected to the system bus 206. It should be appreciated that the network interface unit 214 may also be utilized to connect to other types of networks and remote computing systems. The server 12 also includes an input/output unit 216 for receiving and processing input from a number of other devices, including a touch user interface display screen, an audio input device, or another type of input device. Similarly, the input/output unit 216 may provide output to a touch user interface display screen or other type of output device, including, for example, the I/O device 30 (FIG. 1).

As mentioned briefly above, the mass storage device 213 and/or the RAM 210 of the server 12 can store software instructions and data. The software instructions include an operating system 218 suitable for controlling the operation of the server 12. The mass storage device 213 and/or the RAM 210 also store software instructions and applications 220, that when executed by the processor(s) 20, cause the server 12 to provide the functionality of the system 10 described above (FIG. 1).

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer-implemented method, comprising:
parsing a text of a job posting posted by an entity into parsed text;
performing at least two of:
(i) searching for and identifying a keyword in the parsed text that matches a keyword of an operating description of another entity that did not post the job posting;
(ii) scoring a similarity of the parsed text of the job posting to a parsed text of the operating description of the another entity or to parsed texts of other job postings posted by the another entity and determining that the similarity has a score that exceeds a predetermined minimum similarity score; and
(iii) using a machine learning model to predict a categorization of the job posting that matches a categorization of the operating description of the another entity, the machine learning model being trained using historical job postings categorizations data; and
based on the performing, determining that the job posting sufficiently matches the operating description of the another entity such that the job posting is re-classifiable with respect to the another entity.

2. The computer-implemented method of claim 1, wherein the performing includes all of the steps (i), (ii) and (iii).

3. The computer-implemented method of claim 1, wherein the another entity is an information technology (IT) department of a business enterprise.

4. The computer-implemented method of claim 1, wherein the parsing and the performing are done in response to a request by the another entity for a job posting reclassification report.

5. The computer-implemented method of claim 1, further comprising reporting, via a user interface, that the job posting is re-classifiable with respect to the another entity.

6. The computer-implemented method of claim 5, wherein the reporting includes generating a report indicating each entity of a business enterprise that has posted an active job posting that is re-classifiable with respect to the another entity, the report further indicating, for each entity of the business enterprise that has posted an active job posting that is re-classifiable with respect to the another entity, a number of job postings that are re-classifiable with respect to the another entity.

7. The computer-implemented method of claim 1, wherein each of the entity and the another entity is a line of a business or a department of the same business enterprise.

8. The computer-implemented method of claim 1, further comprising generating an alert that is provided to the another entity, the alert including an indication that the job posting is re-classifiable with respect to the another entity.

9. The computer-implemented method of claim 1, further comprising obtaining the text from one or more webpages using a web crawler.

10. The computer-implemented method of claim 1, wherein the keyword is determined based on the operating description of the another entity.

11. A computer-implemented method, comprising:
parsing a text of a job posting posted by an entity of a business enterprise into parsed text;
performing at least two of:
(i) determining a number of keywords in the parsed text that match keywords of an operating description of an information technology (IT) department of the business enterprise that did not post the job posting and comparing the number to a predefined keyword threshold, and:
if the number is at least as large as the predefined keyword threshold, generating a reclassification indicator; and
if the number is less than the predefined keyword threshold, generating no reclassification indicator;
(ii) scoring a similarity of the parsed text of the job posting to a parsed text of the operating description and to parsed texts of other job postings posted by the IT department and comparing a similarity score determined by the scoring to a predefined similarity threshold, and:
if the similarity score is at least as large as the predefined similarity threshold, generating a reclassification indicator; and
if the similarity score is less than the predefined similarity threshold, generating no reclassification indicator; and
(iii) using a machine learning model to predict a categorization of the job posting, and:
if the categorization matches a categorization of the operating description of the IT department by at least a predefined confidence threshold, generating a reclassification indicator; and
if the categorization matches the categorization of the operating description of the IT department by less than the predefined confidence threshold, generating no reclassification indicator;
if a number of reclassification indicators generated by the performing is at least two, determining that the job posting sufficiently matches the operating description of the IT department such that the job posting is re-classifiable with respect to the IT department; and
if the number of reclassification indicators generated by the performing is less than two, determining that the job posting is not re-classifiable with respect to the IT department.

12. The computer-implemented method of claim 11, wherein the performing includes all of the steps (i), (ii) and (iii).

13. The computer-implemented method of claim 11, wherein the entity is a line of business or a department of the business enterprise other than the IT department.

14. The computer-implemented method of claim 11, wherein the parsing and the performing are done in response to a request by the IT department for a job posting reclassification report.

15. The computer-implemented method of claim 11, further comprising reporting, via a user interface, that the job posting is re-classifiable with respect to the IT department.

16. The computer-implemented method of claim 15, wherein the reporting includes generating a report indicating each entity of the business enterprise that has posted an active job posting that is re-classifiable with respect to the IT department, the report further indicating, for each entity of the business enterprise that has posted an active job posting that is re-classifiable with respect to the IT department, a number of job postings that are re-classifiable with respect to the IT department.

17. The computer-implemented method of claim 11, further comprising generating an alert that is provided to the IT department, the alert including an indication that the job posting is re-classifiable with respect to the IT department.

18. The computer-implemented method of claim 11, further comprising obtaining the text from one or more webpages using a web crawler.

19. The computer-implemented method of claim 11, further comprising:
in response to generating a reclassification indicator, lowering at least one of the predefined keyword threshold, the predefined similarity threshold, and the predefined confidence threshold.

20. A system, comprising:
one or more processors; and
non-transitory computer-readable instructions that, when executed by the one or more processors, cause the system to:
parse a text of a job posting posted by an entity of a business enterprise into parsed text;
perform at least two of:
(i) determine a number of keywords in the parsed text that match keywords of an operating description of an information technology (IT) department of the business enterprise that did not post the job posting and compare the number to a predefined keyword threshold, and:
if the number is at least as large as the predefined keyword threshold, generate a reclassification indicator; and
if the number is less than the predefined keyword threshold, generate no reclassification indicator;
(ii) score a similarity of the parsed text of the job posting to a parsed text of the operating description and to parsed texts of other job postings posted by the IT department and compare a similarity score to a predefined similarity threshold, and:
if the similarity score is at least as large as the predefined similarity threshold, generate a reclassification indicator; and
if the similarity score is less than the predefined similarity threshold, generate no reclassification indicator; and
(iii) use a machine learning model to predict a categorization of the job posting, and:
if the categorization matches a categorization of the operating description of the IT department by at least a predefined confidence threshold, generate a reclassification indicator; and
if the categorization matches the categorization of the operating description of the IT department by less than the predefined confidence threshold, generate no reclassification indicator;
if a number of reclassification indicators generated by the at least two of the steps (i), (ii) and (iii) is at least two, determine that the job posting sufficiently matches the operating description of the IT department such that the job posting is re-classifiable with respect to the IT department; and
if the number of reclassification indicators generated by the at least two of the steps (i), (ii) and (iii) is less than two, determine that the job posting is not re-classifiable with respect to the IT department.
